(19) United States
(12) Patent Application Publication
(10) Pub. No.: US 2001/0034557 A1
(43) Pub. Date: Oct. 25, 2001

(54) Hardware architecture and method for distributed machine control

(76) Inventors: Edison T. Hudson, Chapel Hill, NC (US); James McCormick, Barrington, RI (US); Ronald G. Genise, Raleigh, NC (US); Jerome Dahl, Raleigh, NC (US)

Correspondence Address: David B. Ritchie, Thelen Reid & Priest LLP, P.O. Box 640640, San Jose, CA, 95164-0640, US

(21) Appl. No.: 09/779,913

(22) Filed: Feb. 7, 2001

Related U.S. Application Data
(60) Provisional application No. 60/188,580, filed on Mar. 10, 2000.

(51) Int. Cl. G05B 19/18; G05B 11/01

(52) U.S. Cl. 700/3; 700/78

(57) ABSTRACT

A hardware architecture links control modules to a host computer in a high-speed serial bus network to achieve efficient distributed machine control. Each control module includes a communications unit and a function unit that are coupled to each other as a part of the control module. All communications units are similarly constructed with each having a unique identification set by a component thereof and provide communications between control modules and the host computer. The function unit of each control module is distinctly configured for executing functions specific to the particular control module to which it is attached. The high-speed serial bus provides deterministic synchronization of data transfers between control modules and the host computer using either an isochronous mode and protocol or an asynchronous mode with a fixed real-time clock issuing data requests at fixed time intervals. Data transfers do not require host computer involvement and can occur directly between control modules. Each control module maintains data blocks containing the desired control status from the host computer and the current state of all variables related to the particular control module. These data blocks are available to the host computer and each control module at fixed time intervals without the need for data requests. This permits near real-time intervention or change of state within the controlled machine processes.

### RELATED APPLICATIONS

This application claims the benefit of provisional U.S. patent application Ser. No. 60/188580 filed on Mar. 10, 2000 in the names of Edison T. Hudson, James McCormick, Ronald G. Genise and Jerome Dahl and commonly assigned herewith.

### FIELD OF THE INVENTION

The present invention relates to machine control systems. More particularly, the present invention relates to a hardware architecture and method for distributed machine control. The invention has broad applicability to machine systems requiring controllers which control actuators and/or monitor sensors.

### BACKGROUND OF THE INVENTION

Machine control systems are well known in the art. Such systems include, for example, systems for controlling robotic assembly equipment such as pick and place (or placement) machines. A placement machine is a robotic instrument for picking up electronic and similar parts from component feeders and placing them at their assigned locations on a printed circuit board (PCB). Once all parts are placed, the PCB is placed in a reflow oven and solder paste disposed on the PCB melts forming permanent electrical connections between pads on the PCB and electrical contacts, leads or “pins” on the electrical components.

At present, most machine control systems include physically large control circuits that are centrally located. Many wires and control cables must run between the centrally located control circuits and individual actuators (such as motors of various types), sensors (electronic, electro-optic and video), and like equipment. The result is that with complex systems, the cables which must be routed to various moving parts can be complex, heavy and take up large volumes. For moving parts, added weight increases the cost and size of motors which must be used to achieve a given function. In complex assembly equipment, added weight adds inertia to moving parts which must be precisely located rendering that task more difficult. Accordingly, it would be desirable to provide an architecture for machine control systems, which reduces mass, volume and electrical connections, required to achieve a given task.

### BRIEF DESCRIPTION OF THE INVENTION

A hardware architecture links control modules to a host computer in a high-speed serial bus network to achieve efficient distributed machine control. Each control module includes a communications unit and a function unit that are coupled to each other as a part of the control module. All communications units are similarly constructed with each having a unique identification set by a component thereof and provide communications between control modules and the host computer. The function unit of each control module is distinctly configured for executing functions specific to the particular control module to which it is attached. The high-speed serial bus provides deterministic synchronization of data transfers between control modules and the host computer using either an isochronous mode and protocol or an asynchronous mode with a fixed real-time clock issuing data requests at fixed time intervals. Data transfers do not require host computer involvement and can occur directly between control modules. Each control module maintains data blocks containing the desired control status from the host computer and the current state of all variables related to the particular control module. These data blocks are available to the host computer and each control module at fixed time intervals without the need for data requests. This permits near real-time intervention or change of state within the controlled machine processes.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a schematic diagram of a machine control hardware architecture as applied to a placement machine in accordance with a specific embodiment of the present invention.

FIG. 2 is plan view of components of a hardware module including a common communications device and a unique function device in accordance with a specific embodiment of the present invention.

FIG. 3 is a system block diagram of a module in accordance with a specific embodiment of the present invention.

FIG. 4 is a schematic diagram of a distributed machine control system in accordance with a specific embodiment of the present invention.

### DETAILED DESCRIPTION

Embodiments of the present invention are described herein in the context of a hardware architecture and method for distributed machine control. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

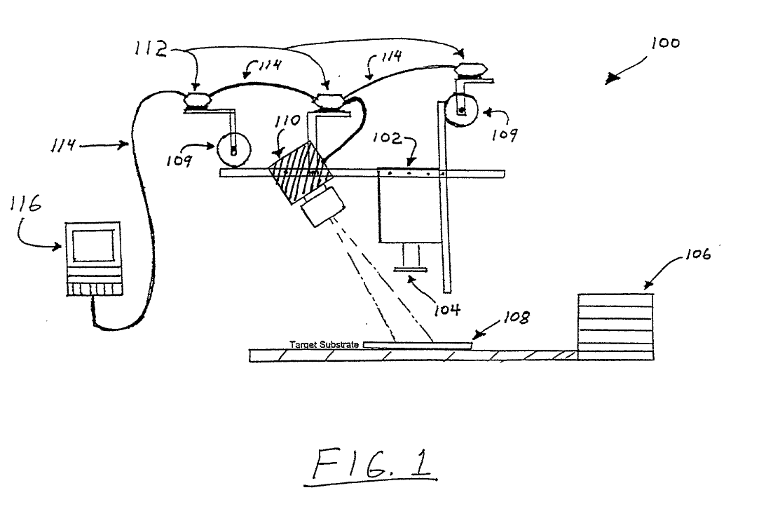

A specific embodiment of the machine control architecture of the present invention is illustrated in FIG. 1 as applied to a placement machine 100. The placement machine 100 has a pick-up head 102 transportable in X, Y, Z and T (rotational) directions which picks up components 104 (with a vacuum pick-up, gripper pick-up, or similar device) from component feeders 106 and transports them for placement onto a target substrate 108 such as a PCB. The components 104 in accordance with this example are typically electrical, electromechanical or electro-optic components and require highly accurate placement onto the target substrate 108 due to typically densely packed input/output (I/O) connections. The placement machine 100 has an imaging system 110 of some kind which observes the components 104 and the target substrate 108 in order to measure, register and align under-side contact and edge features of the components to corresponding target substrate features in order to achieve accurate placement. Placement machine 100 usually includes a number of control modules 112 for driving motors (also referred to as actuators) and sending and receiving digital and analog data. In addition, peripherals of placement machine 100 such as the imaging system 110, camera lighting (not shown), pick-up head 102 and vacuum generators (for use with vacuum pick-ups) may be wired to and controlled by specific data I/O lines of control modules 112. Real-time processing of images captured by the imaging system 110 permits calculation of coordinate feature locations for components 104 and target substrates 108 and corresponding control of the pick-up head 102 motion to achieve proper registration and alignment between the component 104 and target substrate 108.

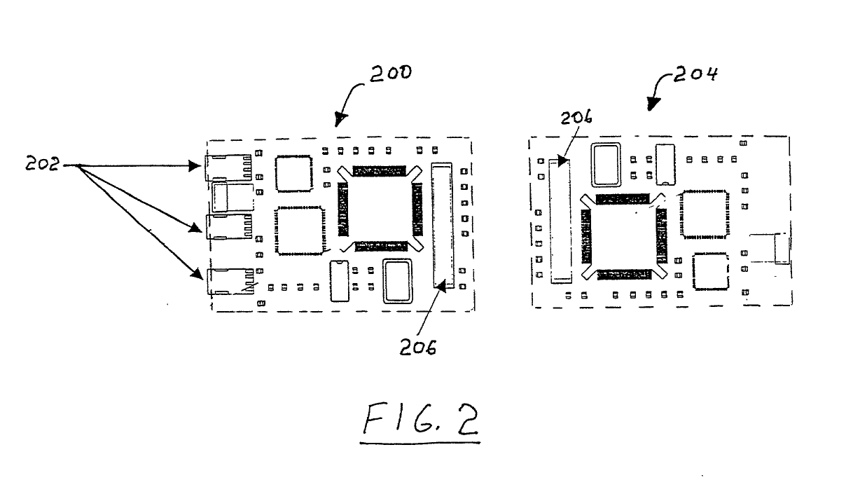

Control modules 112 are preferably positioned on or about the placement machine 100 at critical process locations such as motor control axes 109 and the imaging system 110 so as to minimize cabling. The control modules 112 are connected in a data communications network over a high-speed serial data bus 114 to each other and to a host computer 116. The data communications network may be a high speed network such as those defined in the IEEE Standard for a High Performance Serial Bus—Amendment 1 (IEEE Std. 1394a-2000 (Amendment to IEEE Std 1394-1995)) (Published by the Institute of Electrical and Electronics Engineers, Inc., 3 Park Avenue, New York, N.Y. 10016-5997 on Jun. 30, 2000) (hereinafter referred to as the “IEEE 1394 bus”), and the like. Each control module 112 includes a common communications device 200 which may be a single circuit board as illustrated in FIG. 2 that provides computing power, volatile and non-volatile data storage, and one or more communication ports 202 supporting the high speed serial bus 114. Each communications device 200 on each control module 112 preferably has the same or a similar physical configuration. The communications device 200 on each control module 112 is coupled to a function device 204 which may be a single circuit board using a standardized electrical and data interface 206 which performs signal conditioning, buffering, and power amplification functions. Each function device 204 is distinctly configured to execute functions specific to the particular control module 112 to which it is coupled. The combination of the common communications device 200 with a unique function device 204 constitutes a control module 112 that can perform a variety of functions. These functions include closed loop motion control of various types of motors using digital encoder, analog or video sensor feedback in combination with digital algorithms such as PID (proportional, integral, derivative) control providing real-time position, velocity and torque control and motor phase commutation. Machine vision functions using digital image acquisition and transmission without the use of specialized host resident hardware such as frame grabbers is of particular benefit in the placement machine 100 application. Other functional capabilities of the control module 112 include but are not limited to logic control with electrical opto-isolation for input or output signals, analog to digital and digital to analog conversion of voltage, current, or resistance from sensors or other electromagnetic sources, communication bridging and translation to and from other serial (or other) buses such as CANBUS, USB, RS232/422, and Ethernet, power control and amplification using pulse width modulation methods to create variable output levels of power for process functions such as lighting and heating, and real-time process variable control using any of the above digital or analog inputs or outputs.

The distinct configuration and corresponding functional capability of any one control module 112 is uniquely identified by a coded serial number that is hardware embedded and non-programmable in each module 112. Control modules 112 of the same type (i.e. modules having identical function devices 204 in addition to common communications devices 200) are also enumerated by a unique hardware embedded serial number. Each control module 112 transmits its coded serial number to the “root node” (which is usually host computer 116) upon a start-up initialization procedure causing the host computer 116 to assign a distinct network address to each control module 112. The host computer 116 then downloads appropriate control firmware that it has stored in an archive to the common communications device 200 in each control module 112 and thus configures the functionality and performance characteristics of each control module 112 as needed based on the application requirements for each control module 112. The capabilities of the host computer 116 controlled architecture combined with the “plug and work” nature of the control modules 112 and high-speed serial bus 114 permits a rapid configuration of many functions.

The high speed serial bus 114 linking the control modules 112 and host computer 116 has a high data transfer rate that typically ranges from about 100 megabits per second to about 3 gigabits per second (referred to herein as “high-speed”). In addition, the serial bus provides a mechanism for time deterministic data transfers such as the isochronous mode of an IEEE 1394 bus. In an IEEE 1394 bus isochronous mode, all real-time control system variables such as PID parameters, motion information and the state of digital and analog I/O are transferred from the host computer 116 to the control module 112 and vice versa at a fixed time interval using the isochronous protocol. Thus sensor data, captured by sensors coupled to digital or analog inputs of the control module, can be transferred to the host computer for use in calculations such as PID servo loops, machine vision algorithms, and the like. In an IEEE 1394 bus or similar serial bus, this can also be accomplished using an asynchronous mode of communication by establishing a fixed real-time clock that issues a read request to each control module 112 at a fixed time interval. Immediately following such a request, the control module 112 issues a write request to load its control variable data to the host computer 116.

In operation, the synchronous communication between the host computer 116 and physically remote control modules 112 over the high speed serial bus 114 occurs in a memory mapped fashion which emulates the remote control modules 112 being actually resident in host computer 116. Each control module 112 maintains an in-page data block containing a complete set or state table of the desired control state commands from the host computer 116 and an out-page data block containing the current state of all control variables within that particular control module 112. In addition, the host computer 116 maintains in-page and out-page data blocks for each control module 112 attached to the network. The time synchronized transmission mode of the hardware architecture guarantees that the state of each control module 112 is known within a deterministic time domain. Therefore all control variables are available to host computer 116 at a repeatable interval without requiring a specific request for such information. This permits near real-time intervention or change-of-state of any control variable for any control module 112 without the need to interrupt the normal stream of events at the control modules 112 or in the host computer 116. The updating or painting of the state of the in-page and out-page data blocks takes place at the lowest level in host computer 116 so as to have minimal impact on higher level functions. Unlike SERCOS (the well-known SErial Real-time COmmunication System), an open interface specification, designed for high-speed serial communication of standardized closed-loop data, or other known control protocols, no command interpretation or parsing and no polling is required. The updates are simply accomplished automatically and repeatedly at fixed time intervals. Therefore, system overheads at both host computer 116 and the control modules 112 are both minimal and constant with respect to computing resource demand.

Furthermore, the asynchronous and isochronous communication modes provided by the high-speed serial bus system, such as in the IEEE 1394 bus, permit a “peer-to-peer” communication. This means that no interaction with the host computer 116 is required to set-up or transfer data to any valid control module 112 within the network. These data transfers do not require permission from, redirection from or routing to the host computer 116. As an example, in the placement machine 100 application of FIG. 1, a motor control axis can receive position commands via direct state table or in-page data block updates from another control module 112 performing a sensor function with no host computer 116 interaction.

Additionally, the hardware architecture provides for data error checking with at least two error checks occurring at each transfer of data between a control module 112 and host computer 116. These error checks include a checksum on data integrity of the in-page data blocks and the out-page data blocks and a recirculating message sequence number for message order integrity between control modules 112 and the host computer 116.

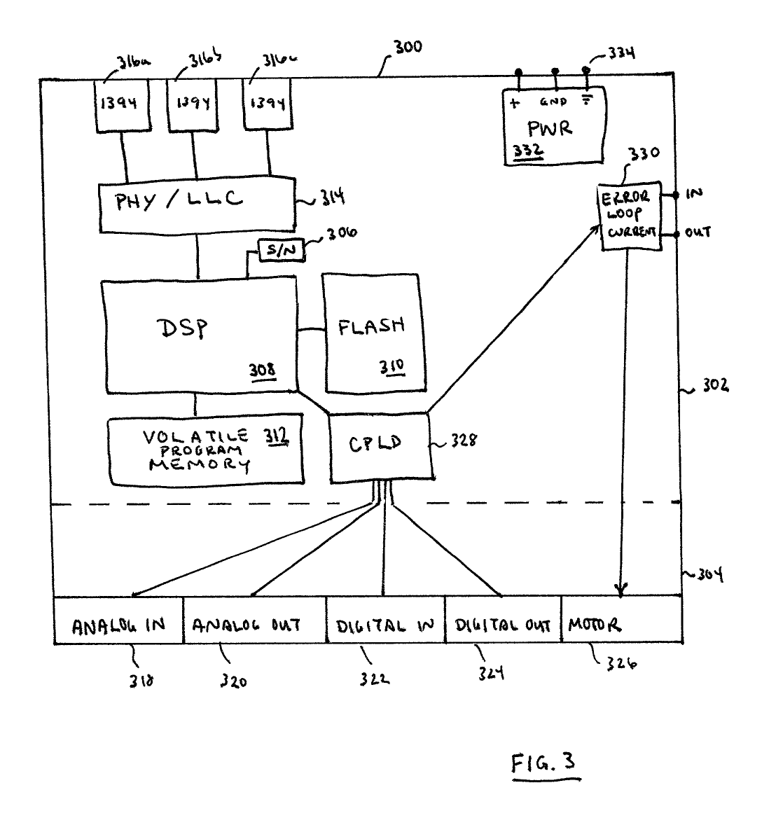

FIG. 3 is a system block diagram of a module in accordance with a presently preferred specific embodiment of the present invention. Module 300 includes a base processor/communications unit 302 and a function unit 304. Base processor/communications unit 302 may be present in each module present in a particular machine control system. Serial number chip 306 provides a unique serial number to processor/communications device 302. Digital signal processor (DSP) 308 may be a model TMS320F240 available from Texas Instruments. Flash memory 310 provides a bootstrap loadable program for initially configuring DSP 308 upon power-up. DSP 308 is generally programmed by the instructions in flash memory 310 to request download of software from a host computer after power-up and bootstrap load is completed. Once the software is downloaded from the host it is stored in volatile program memory 312.

DSP 308 communicates off-module via a conventional PHY (physical layer device) and LLC (link layer) 314 with serial ports 316a, 316b and 316c that may be IEEE 1394 bus serial ports and which together form a three-port IEEE 1394 bus hub of which some of the serial ports may be 4-wire (unpowered) ports and others may be 6-wire (powered) ports under the IEEE 1394 standard, as desired. To communicate with function unit 304 which in this embodiment is disposed on a separate PCB and connected to the PCB upon which processor/communications unit 302 is disposed via a multi-connector block connector that carries various signals and voltage levels. Function unit 304 may contain circuitry and ports supporting such communications activities as Analog Input (318), Analog Output (320), Digital Input (322), Digital Output (324), and various types of motor controls (326). DSP 308 may communicate with function unit 304 via a programmable logic device 328 in a conventional manner. In order to provide an emergency stop function to motorized equipment under control of module 300, motor control signals are preferably routed via error loop current block 330. If a low current signal routed through various components of the machine control system and through the “IN” and “OUT” ports of error loop current block 330 is interrupted, the signal(s) controlling the motorized components will cease to pass to the motorized components even if the DSP 308 has crashed or locked up. Error loop current block 330 operates, for example, by providing current to the gate of a switch transistor which allows motor control signals to pass from the switch transistor's source to drain. Other electrically controlled switch technologies (e.g., relays, opto-isolators, etc.) could be used as well as will now be apparent to those of ordinary skill in the art of circuit design. This feature is provided as a safety feature to provide a positive mechanism for motor shutdown in the case of an emergency or detected anomaly. Power block 332 receives power from an external source on lines “+” and “GND”. Chassis ground input 334 is preferably isolated from “GND” input.

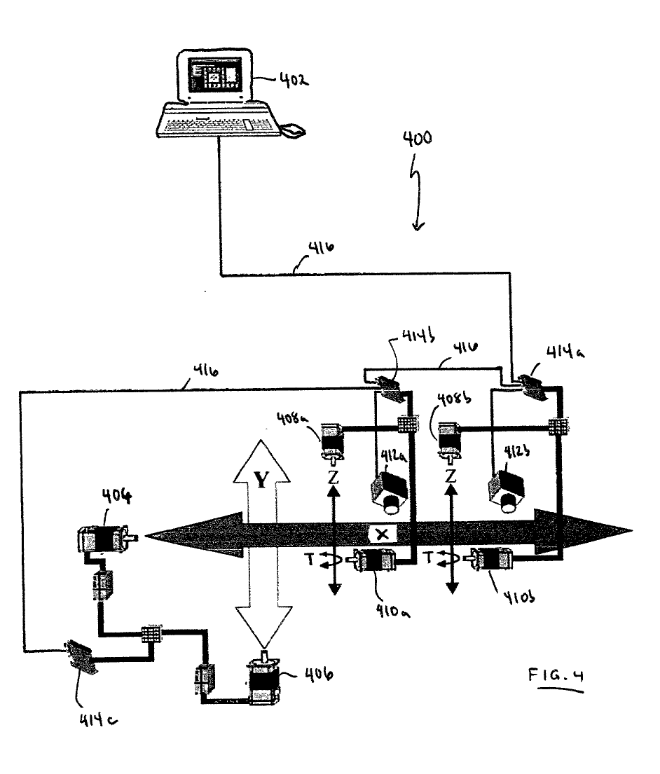

FIG. 4 is a schematic diagram of a distributed machine control system in accordance with a specific embodiment of the present invention. FIG. 4 illustrates a typical application for the distributed machine control system of the present invention. A six axis motion system 400 under the control of a host computer 402 includes a number of actuators 404 (X-axis), 406 (Y-axis), 408a and 408b (Z-axis), and 410a and 410b (T-axis). Cameras 412a and 412b are IEEE 1394-type cameras and are present to provide machine vision control. Machine vision algorithms and servo-loops are preferably implemented by a corresponding control module (e.g., control module 414b processes machine vision for camera 412a). In this embodiment a number of control modules 414a, 414b and 414c provide control to the various actuators and cameras. Control modules 414a, 414b and 414c may be coupled to one another using an IEEE 1394 bus 416 including flexible serial data cables and may be connected in daisy-chain fashion or in a tree fashion.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for controlling an actuator, comprising:
storing a program of instructions on a host computer;
linking the host computer to a control module;
coupling the control module to the actuator;
retrieving the program of instructions from the host computer and loading it into the control module; and
controlling the actuator with the control modulator.

2. A method in accordance with claim 1 wherein said retrieving is performed immediately after power is applied to the control module.

3. A method in accordance with claim 1 wherein said linking is performed with a high speed serial bus implemented over a flexible cable.

4. A method in accordance with claim 3 wherein said high speed serial bus is an IEEE 1394 bus.

5. A method for controlling a first and a second actuator, comprising:
storing a first and a second program of instructions on a host computer;
linking the host computer to a first and a second control module;
coupling the first control module to the first actuator and the second control module to the second actuator;
retrieving the first program of instructions from the host computer and loading it into the first control module;
retrieving the second program of instructions from the host computer and loading it into the second control module;
controlling the first actuator with the first control module; and
controlling the second actuator with the second module.

6. A method in accordance with claim 5 wherein said retrieving the first program is performed immediately after power is applied to the first control module.

7. A method in accordance with claim 6 wherein said retrieving the second program is performed immediately after power is applied to the second control module.

8. A method in accordance with claim 5 wherein said linking is performed with a high speed serial bus implemented over a flexible cable.

9. A method in accordance with claim 8 wherein said high-speed serial bus is an IEEE 1394 bus.

10. A method for distributed machine control, comprising:
storing a first and a second program of instructions on a host computer;
linking the host computer to a first control module;
linking the first control module to a second control module;
coupling the first control module to a first actuator and the second control module to a second actuator;
retrieving the first program of instructions from the host computer and loading it into the first control module;
retrieving the second program of instructions from the host computer and loading it into the second control module;
controlling the first actuator with the first control module; and
controlling the second actuator with the second module.

11. A method in accordance with claim 10 wherein said linking the host computer is performed with a high speed serial bus implemented over a flexible cable.

12. A method in accordance with claim 11 wherein said first control module includes a hub supporting the connection of at least one additional device coupled to the hub with a high speed serial bus implemented over a flexible cable.

13. A method in accordance with clam 12 wherein said linking the first control module computer is performed with a high speed serial bus implemented over a flexible cable.

14. A method in accordance with claim 13 wherein said retrieving the first program is performed immediately after power is applied to the first control module.

15. A method in accordance with claim 14 wherein said retrieving the second program is performed immediately after power is applied to the second control module.

16. A method in accordance with claim 10 wherein said retrieving the first program of instructions is accomplished in response to first transmitting from the first control module a unique identification permanently stored in a component of the first control module.

17. A method in accordance with claim 16 wherein said retrieving the second program of instructions is accomplished in response to first transmitting from the second control module a unique identification permanently stored in a component of the second control module.

18. A method for distributed machine control, comprising:
controlling a first actuator with a first control module, said first module including a first processor carrying out a program of instructions and generating a first set of signals for controlling said first actuator;
controlling a second actuator with a second control module, said second module including a second processor carrying out a program of instructions and generating a second set of signals for controlling said second actuator;
linking said first set of signals through a first error current block disposed in said first module to said first actuator, said first error current block receiving and transmitting an error current loop signal and interrupting said first set of signals if said error current loop signal is interrupted;
linking said second set of signals through a second error current block disposed in said second module to said second actuator, said second error current block receiving and transmitting said error current loop signal and interrupting said second set of signals if said error current loop signal is interrupted;
detecting an error condition; and
interrupting said error current loop signal upon detection of said error condition.

19. A method in accordance with claim 18 wherein said detecting is performed at least by an emergency stop switch.

20. A control module for controlling an actuator, said control module comprising:
a communications/processor unit including
a component specifying a unique identification for the communications/processor module;
a processor;
a non-volatile memory providing a bootstrap load program of instructions for the processor; and
a volatile program memory for storing a program of instructions for controlling the processor; and
a function unit for driving the actuator, said communications/processor unit electrically coupled to said function unit.

21. A control module in accordance with claim 20 wherein said communications/processor unit is coupled to said function unit through an error current block having an error current loop input and an error current loop output, said error current block interrupting at least one signal to said actuator from said processor whenever current is interrupted in said error current loop.

22. An apparatus for controlling an actuator, comprising:
a host computer;
means for storing a program of instructions on the host computer;
means for linking the host computer to a control module;
means for coupling the control module to the actuator;
means for retrieving the program of instructions from the host computer and loading it into the control module; and
means for controlling the actuator with the control modulator.

23. An apparatus in accordance with claim 22 wherein said means for retrieving operates immediately after power is applied to the control module.

24. An apparatus in accordance with claim 22 wherein said means for linking includes a high-speed serial bus implemented over a flexible cable.

25. An apparatus in accordance with claim 24 wherein said high-speed serial bus is an IEEE 1394 bus.

26. An apparatus for controlling a first and a second actuator, comprising:
a host computer;
means for storing a first and a second program of instructions on the host computer;
means for linking the host computer to a first and a second control module;
means for coupling the first control module to the first actuator and the second control module to the second actuator;
means for retrieving the first program of instructions from the host computer and loading it into the first control module;
means for retrieving the second program of instructions from the host computer and loading it into the second control module;
means for controlling the first actuator with the first control module; and
means for controlling the second actuator with the second module.

27. An apparatus in accordance with claim 26 wherein said means for retrieving the first program operates immediately after power is applied to the first control module.

28. An apparatus in accordance with claim 27 wherein said means for retrieving the second program operates immediately after power is applied to the second control module.

29. An apparatus in accordance with claim 26 wherein said means for linking includes a high-speed serial bus implemented over a flexible cable.

30. An apparatus in accordance with claim 29 wherein said high-speed serial bus is an IEEE 1394 bus.

31. An apparatus for distributed machine control, comprising:
a host computer;
means for storing a first and a second program of instructions on the host computer;
means for linking the host computer to a first control module;
means for linking the first control module to a second control module;
means for coupling the first control module to a first actuator and the second control module to a second actuator;
means for retrieving the first program of instructions from the host computer and loading it into the first control module;
means for retrieving the second program of instructions from the host computer and loading it into the second control module;
means for controlling the first actuator with the first control module; and
means for controlling the second actuator with the second module.

32. An apparatus in accordance with claim 31 wherein said means for linking the host computer includes a high-speed serial bus implemented over a flexible cable.

33. An apparatus in accordance with claim 32 wherein said first control module includes a hub supporting the connection of at least one additional device coupled to the hub with a high speed serial bus implemented over a flexible cable.

34. An apparatus in accordance with clam 33 wherein said means for linking the first control module computer includes a high-speed serial bus implemented over a flexible cable.

35. An apparatus in accordance with claim 34 wherein said means for retrieving the first program operates immediately after power is applied to the first control module.

36. An apparatus in accordance with claim 35 wherein said means for retrieving the second program operates immediately after power is applied to the second control module.

37. An apparatus in accordance with claim 31 wherein said means for retrieving the first program of instructions is responsive to first transmitting from the first control module a unique identification permanently stored in a component of the first control module.

38. An apparatus in accordance with claim 37 wherein said means for retrieving the second program of instructions is responsive to first transmitting from the second control module a unique identification permanently stored in a component of the second control module.

39. An apparatus for distributed machine control, comprising:
means for controlling a first actuator with a first control module, said first module including a first processor carrying out a program of instructions and generating a first set of signals for controlling said first actuator;
means for controlling a second actuator with a second control module, said second module including a second processor carrying out a program of instructions and generating a second set of signals for controlling said second actuator;
means for linking said first set of signals through a first error current block disposed in said first module to said first actuator, said first error current block receiving and transmitting an error current loop signal and interrupting said first set of signals if said error current loop signal is interrupted;
means for linking said second set of signals through a second error current block disposed in said second module to said second actuator, said second error current block receiving and transmitting said error current loop signal and interrupting said second set of signals if said error current loop signal is interrupted;
means for detecting an error condition; and
means for interrupting said error current loop signal upon detection of said error condition.

40. An apparatus in accordance with claim 39 wherein said means for detecting includes at least an emergency stop switch.

41. A method for controlling an actuator, comprising:
storing a program of instructions on a host computer;
linking the host computer to a control module;
coupling the control module to the actuator;
retrieving the program of instructions from the host computer and loading it into the control module;
controlling the actuator with the control modulator;
sending state information reflecting a state of the control module from the control module to the host computer repeatedly at fixed time intervals; and
storing the state information in memory of the host computer between said fixed time intervals.

42. A method in accordance with claim 41 wherein said sending is performed using the IEEE 1394 bus isochronous protocol mode.

43. A method in accordance with claim 41 wherein said sending is performed in response to a real-time clock causing the issuance of a read request to said control module at fixed time intervals.

44. A method in accordance with claim 41 wherein said sending and said storing do not require permission from, redirection from or routing by said host computer.

45. A method in accordance with claim 41 wherein said control module maintains an in-page data block containing a complete set of desired control states from the host computer and an out-page data block containing the current state of all variables maintained with the control module.

46. A method in accordance with claim 45 further comprising checking the state information for errors at least twice during each said time interval.

47. A method in accordance with claim 46 wherein the at least two error checks include a checksum on data integrity of the in-page data block and the out-page data block and a recirculating message sequence number used to verify message order integrity.

48. A method in accordance with claim 47, wherein said checksum and said recirculating message sequence number are data fields appended to the in-page data block and the out-page data block.

49. An apparatus for controlling an actuator, comprising:
a host computer;
means for storing a program of instructions on the host computer;
a control module;
means for linking the host computer to said control module;
means for coupling said control module to the actuator;
means for retrieving the program of instructions from the host computer and loading it into said control module;
means for controlling the actuator with said control modulator;
means for sending state information reflecting a state of said control module from said control module to the host computer repeatedly at fixed time intervals; and
means for storing the state information in memory of the host computer between said fixed time intervals.

50. An apparatus in accordance with claim 49 wherein said means for sending utilizes the IEEE 1394 bus isochronous protocol mode.

51. An apparatus in accordance with claim 49 wherein said means for sending is responsive to a real-time clock causing the issuance of a read request to said control module at fixed time intervals.

52. An apparatus in accordance with claim 49 wherein said means for sending and said means for storing do not require permission from, redirection from or routing by said host computer.

53. An apparatus in accordance with claim 49 wherein said control module maintains an in-page data block containing a complete set of desired control states from the host computer and an out-page data block containing the current state of all variables maintained with the control module.

54. An apparatus in accordance with claim 53 further comprising means for checking the state information for errors at least twice during each said time interval.

55. An apparatus in accordance with claim 54 wherein the at least two error checks include a checksum on data integrity of the in-page data block and the out-page data block and a recirculating message sequence number used to verify message order integrity.

56. An apparatus in accordance with claim 55, wherein said checksum and said recirculating message sequence number are data fields appended to the in-page data block and the out-page data block.

57. A method for coordinating and synchronizing data flow between a control module and a host computer, said method comprising:
linking the control module to the host computer via a high-speed serial data bus, the high-speed serial data bus utilizing an isochronous transfer mode having a fixed time interval between transfers; and
transferring a current status variable data block from said control module to the host computer and transferring a desired status variable data block from the host computer to said control module during each said time interval via said high-speed serial data bus.

58. A method in accordance with claim 57, wherein said control module has a unique identification stored on a component of said control module and transmitted to the host computer with each transmission taking place from said control module to the host computer via said high-speed serial data bus.

59. An apparatus for coordinating and synchronizing data flow between a control module and a host computer, said apparatus comprising:
means for linking the control module to the host computer via a high-speed serial data bus, the high-speed serial data bus utilizing an isochronous transfer mode having a fixed time interval between transfers; and
means for transferring a current status variable data block from the control module to the host computer and transferring a desired status variable data block from the host computer to the control module during each said time interval via said high-speed serial data bus.

60. A method in accordance with claim 59, wherein the control module has a unique identification stored on a component thereof and transmitted to the host computer with each transmission taking place from the control module to the host computer via said high-speed serial data bus.

61. A method in accordance with claim 5 wherein said linking includes providing a first connection between the host computer and a hub disposed in the first control module and providing a second connection between the hub disposed in the first control module and a second control module.

62. A method for controlling an actuator in a machine having at least one control module for providing control signals to the actuator and a host computer for controlling the control module, said method comprising:
linking the host computer with the control module via a high-speed data bus;
coupling the control module to the actuator;
maintaining and updating a first set of data at the control module;
transmitting said first set of data to the host computer periodically at fixed intervals of time without polling;
maintaining and updating a second set of data at the host computer; and
transmitting said second set of data to the control module periodically at fixed intervals of time without polling.

63. An apparatus for controlling an actuator in a machine having at least one control module for providing control signals to the actuator and a host computer for controlling the control module, said apparatus comprising:
means for linking the host computer with the control module via a high-speed data bus;
means for coupling the control module to the actuator;
means for maintaining and updating a first set of data at the control module;
means for transmitting said first set of data to the host computer periodically at fixed intervals of time without polling;
means for maintaining and updating a second set of data at the host computer; and
means for transmitting said second set of data to the control module periodically at fixed intervals of time without polling.

64. A method for sensing and responding to a condition sensed by a sensor coupled to a control module, the control module coupled to a host computer, said method comprising:
linking the host computer with the control module via a high-speed data bus;
sensing a condition with the sensor;
reporting the condition to the control module;
maintaining and updating a first set of data dependent upon the condition at the control module; and
transmitting said first set of data to the host computer periodically at fixed intervals of time without polling.

65. An apparatus for sensing and responding to a condition sensed by a sensor coupled to a control module, the control module coupled to a host computer, said apparatus comprising:
means for linking the host computer with the control module via a high-speed data bus;
means for sensing a condition with the sensor;
means for reporting the condition to the control module;
means for maintaining and updating a first set of data dependent upon the condition at the control module; and
means for transmitting said first set of data to the host computer periodically at fixed intervals of time without polling.
